(19) United States
(12) Patent Application Publication
(10) Pub. No.: US 2024/0244450 A1
(43) Pub. Date: Jul. 18, 2024

(54) METHODS AND APPARATUSES FOR CONFIGURING TRANSMISSION POLICY, DEVICE AND STORAGE MEDIUM

(71) Applicant: Beijing Xiaomi Mobile Software Co., Ltd., Beijing (CN)

(72) Inventor: Yang LIU, Beijing (CN)

(73) Assignee: Beijing Xiaomi Mobile Software Co., Ltd., Beijing (CN)

(21) Appl. No.: 18/558,903

(22) PCT Filed: May 7, 2021
(86) PCT No.: PCT/CN2021/092194

§ 371 Date: Nov. 3, 2023

(51) Int. Cl. H04W 16/28; H04W 72/1268; H04W 72/231; H04W 76/20

(52) U.S. Cl. CPC H04W 16/28; H04W 72/1268; H04W 72/231; H04W 76/20

(57) ABSTRACT

A method for configuring a transmission policy includes transmitting a configuration signaling to a first terminal, where the configuration signaling includes a transmission policy of an uplink channel; where the transmission policy is configured to, when using different transmitting beams in two adjacent repeated transmissions of the uplink channel to perform the transmissions toward different transmit-receive points (TRPs) of a same network device, determine a first transmission resource and a second transmission resource for performing the two adjacent repeated transmissions; there is a beam switching time for switching beam direction between the first transmission resource and the second transmission resource; the first transmission resource corresponds to a prior transmission occasion in two adjacent transmission occasions for transmissions of the uplink channel; and the second transmission resource corresponds to a late transmission occasion in the two adjacent transmission occasions for transmissions of the uplink channel.

### CROSS REFERENCE TO RELATED APPLICATIONS

This application is a National Phase of International Application No. PCT/CN2021/092194, filed on May 7, 2021, the entire contents of which are incorporated herein by reference in their entireties.

### TECHNICAL FIELD

The present disclosure relates to the field of wireless communication technologies, and in particular to methods and apparatuses for configuring a transmission policy, a device and a storage medium.

### BACKGROUND

The 3rd generation partnership project (3GPP) introduces multi-transmit-receive point (TRP)-based repeated transmission technology into the 5th generation new radio (NR) system.

Based on multiple TRPs, a terminal device may perform repeated transmission of uplink channel toward multiple TRPs of one base station. When performing repeated transmission toward the TRPs of different directions, the terminal device needs to perform beam direction switching.

### SUMMARY

The embodiments of the present disclosure provide methods and apparatuses for configuring a transmission policy, a device and a storage medium, in which a beam switching time can be introduced during transmission of an uplink channel. The technical solution is described below.

According to one aspect of the present disclosure, there is provided a method for configuring a transmission policy, which is performed by a network device. The method includes:

transmitting a configuration signaling to a first terminal, where the configuration signaling includes a transmission policy of an uplink channel;

where the transmission policy is configured to, when using different transmitting beams in two adjacent repeated transmissions of the uplink channel to perform the transmissions toward different transmit-receive points (TRPs) of a same network device, determine a first transmission resource and a second transmission resource for performing the two adjacent repeated transmissions; there is a beam switching time for switching beam direction between the first transmission resource and the second transmission resource; the first transmission resource corresponds to a prior transmission occasion in two adjacent transmission occasions for transmissions of the uplink channel; and the second transmission resource corresponds to a late transmission occasion in the two adjacent transmission occasions for transmissions of the uplink channel.

According to one aspect of the present disclosure, there is provided a method for configuring a transmission policy, which is performed by a terminal device. The method includes:

receiving a configuration signaling from a network device, where the configuration signaling includes a transmission policy of an uplink channel;

wherein the transmission policy is configured to, when using different transmitting beams in two adjacent repeated transmissions of the uplink channel to perform the transmissions toward different transmit-receive points (TRPs) of a same network device, determine a first transmission resource and a second transmission resource for performing the two adjacent repeated transmissions; there is a beam switching time for switching beam direction between the first transmission resource and the second transmission resource; the first transmission resource corresponds to a prior transmission occasion in two adjacent transmission occasions for transmissions of the uplink channel; and the second transmission resource corresponds to a late transmission occasion in the two adjacent transmission occasions for transmissions of the uplink channel.

According to one aspect of the present disclosure, there is provided a network device, which includes a processor and a transceiver connected with the processor; where,

the transceiver is configured to transmit a configuration signaling to a first terminal, where the configuration signaling includes a transmission policy of an uplink channel;

where the transmission policy is configured to, when using different transmitting beams in two adjacent repeated transmissions of the uplink channel to perform the transmissions toward different transmit-receive points (TRPs) of a same network device, determine a first transmission resource and a second transmission resource for performing the two adjacent repeated transmissions; there is a beam switching time for switching beam direction between the first transmission resource and the second transmission resource; the first transmission resource corresponds to a prior transmission occasion in two adjacent transmission occasions for transmissions of the uplink channel; and the second transmission resource corresponds to a late transmission occasion in the two adjacent transmission occasions for transmissions of the uplink channel.

According to one aspect of the present disclosure, there is provided a terminal device, which includes a processor and a transceiver connected with the processor; where,

the transceiver is configured to receive a configuration signaling from a network device, where the configuration signaling includes a transmission policy of an uplink channel;

where the transmission policy is configured to, when using different transmitting beams in two adjacent repeated transmissions of the uplink channel to perform the transmissions toward different transmit-receive points (TRPs) of a same network device, determine a first transmission resource and a second transmission resource for performing the two adjacent repeated transmissions; there is a beam switching time for switching beam direction between the first transmission resource and the second transmission resource; the first transmission resource corresponds to a prior transmission occasion in two adjacent transmission occasions for transmissions of the uplink channel; and the second transmission resource corresponds to a late transmission occasion in the two adjacent transmission occasions for transmissions of the uplink channel.

### BRIEF DESCRIPTION OF THE DRAWINGS

To describe the technical solutions in the embodiments of the present disclosure more clearly, drawings required in descriptions of the embodiments of the present disclosure will be briefly introduced below. It is apparent that the drawings described below are merely some embodiments of the present disclosure and other drawings may be obtained by those of ordinary skill in the prior art based on these drawings, without making creative work.

FIG. 1 is a schematic diagram illustrating a system architecture according to an exemplary embodiment of the present disclosure.

FIG. 2 is a flowchart illustrating a method for configuring a transmission policy according to an exemplary embodiment of the present disclosure.

FIG. 3 is a flowchart illustrating a method for configuring a transmission policy according to another exemplary embodiment of the present disclosure.

FIG. 4 is a flowchart illustrating a method for configuring a transmission policy according to yet another exemplary embodiment of the present disclosure.

FIG. 5 is a flowchart illustrating a method for configuring a transmission policy according to still another exemplary embodiment of the present disclosure.

FIG. 6 is a schematic diagram illustrating inter-slot repeated transmission of a physical uplink control channel (PUCCH) in a method for configuring a transmission policy according to an exemplary embodiment of the present disclosure.

FIG. 7 is a schematic diagram illustrating inter-slot repeated transmission of a physical uplink shared channel (PUSCH) in a method for configuring a transmission policy according to an exemplary embodiment of the present disclosure.

FIG. 8 is a schematic diagram illustrating inter-slot repeated transmission of the PUSCH in a method for configuring a transmission policy according to an exemplary embodiment of the present disclosure.

FIG. 9 is a schematic diagram illustrating inter-slot repeated transmission of the PUSCH in a method for configuring a transmission policy according to an exemplary embodiment of the present disclosure.

FIG. 10 is a schematic diagram illustrating inter-slot repeated transmission of the PUSCH in a method for configuring a transmission policy according to an exemplary embodiment of the present disclosure.

FIG. 11 is a schematic diagram illustrating an intra-slot frequency-hopping-resource-based repeated transmission of the PUCCH in a method for configuring a transmission policy according to an exemplary embodiment of the present disclosure.

FIG. 12 is a schematic diagram illustrating an intra-slot frequency-hopping-resource-based repeated transmission of the PUCCH in a method for configuring a transmission policy according to an exemplary embodiment of the present disclosure.

FIG. 13 is a structural block diagram illustrating an apparatus for configuring a transmission policy according to an exemplary embodiment of the present disclosure.

FIG. 14 is a structural block diagram illustrating an apparatus for configuring a transmission policy according to another exemplary embodiment of the present disclosure.

FIG. 15 is a structural schematic diagram illustrating a communication device provided by an exemplary embodiment of the present disclosure.

### DETAILED DESCRIPTION OF THE EMBODIMENTS

In order to make the objects, the technical solutions and advantages of the present disclosure clearer, the embodiments of the present disclosure will be further detailed below in combination with the drawings.

Exemplary embodiments will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

The terms used in the present disclosure are used for the purpose of describing particular embodiments only, and are not intended to limit the present disclosure. Terms determined by “a”, “the” and “said” in their singular forms in the present disclosure and the appended claims are also intended to include plurality, unless clearly indicated otherwise in the context. It should also be understood that the term “and/or” as used herein refers to and includes any and all possible combinations of one or more of the associated listed items.

It is to be understood that, although the terms “first,” “second,” “third,” and the like may be used in the present disclosure to describe various information, such information should not be limited to these terms. These terms are only configured to distinguish one category of information from another. For example, without departing from the scope of the present disclosure, first information may be referred as second information; and similarly, the second information may also be referred as the first information. Depending on the context, the term “if” as used herein may be interpreted as “when” or “upon” or “in response to determining”.

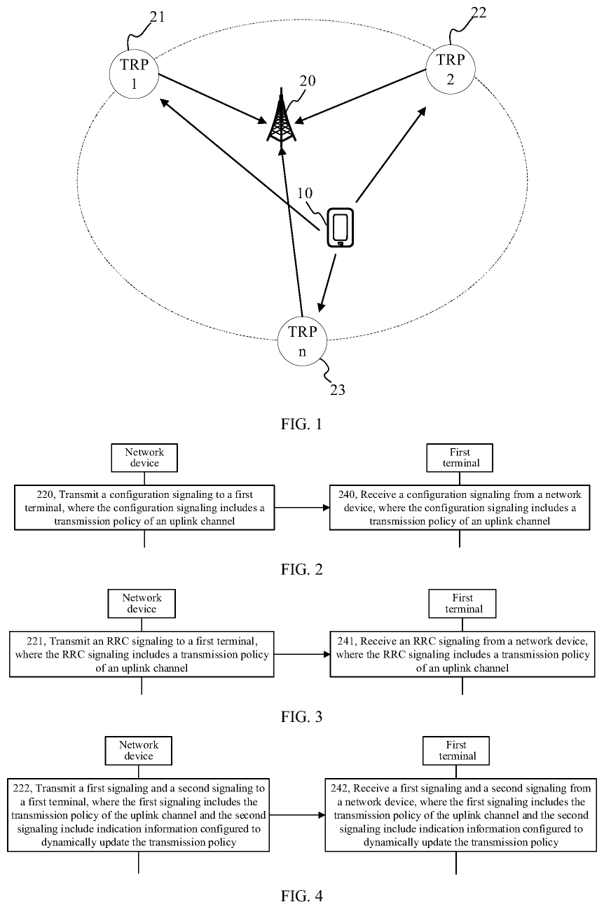

With reference to FIG. 1, it shows a schematic diagram of a system architecture according to one embodiment of the present disclosure. The system architecture may include a terminal device 10 and a network device 20.

Usually, there are a plurality of terminal devices 10, one or more of which may be distributed in a cell managed by each network device 20. The terminal device 10 may include a palm-held device, a vehicle-mounted device, a wearable device and a computing device having a particular wireless communication function or another processing device connected to a demo as well as various types of user equipment (UE) and mobile stations (MS) and the like. For ease of descriptions, in the embodiments of the present disclosure, the above devices are collectively referred to as terminal device.

The network device 20 is an apparatus deployed in an access network to provide wireless communication function to the terminal device 10. The network device 20 may include various types of macro base stations, micro base station, repeater stations and access points and the like. In a system employing wireless access technology, the devices with the network device functions may be named differently, for example, in a 5G NR system, it is referred to as gNodeB or gNB. Along with evolution of the communication technologies, the name of “network device” may change. For ease of descriptions, in the embodiments of the present disclosure, the above apparatuses providing wireless communication functions to the terminal device 10 are collectively referred to as network device.

Illustratively, multiple transmit-receive points (TRPs) 21, 22, 23 may be deployed in one network device 20, for example, the network device 20 may correspond to TRP1, TRP2, . . . and TRPn. The terminal device may use different transmitting beams to perform repeated transmission of an uplink channel toward different TRPs, and the network device 20 may receive the repeated transmission of the uplink channel from the terminal device via multiple TRPs. Illustratively, since different TRPs have different orientations relative to the terminal device, the terminal device needs to use the transmitting beams of different beam directions to perform transmission toward the TRPs of the corresponding directions, so as to perform repeated transmission of the uplink channel.

The “5G NR system” in the embodiments of the present disclosure may also be referred to as 5G system or NR system as long as those skilled in the arts can understand its meaning. The technical solutions in the embodiments of the present disclosure may be applicable to a 5G NR system or to an evolved system subsequent to the 5G NR system.

With reference to FIG. 2, it shows a flowchart illustrating a method for configuring a transmission policy according to an embodiment of the present disclosure. The method may be applied to a system architecture shown in FIG. 1. The method includes the following steps.

At step 220, the network device transmits a configuration signaling to the first terminal, where the configuration signaling includes a transmission policy of an uplink channel.

where the transmission policy is configured to, when using different transmitting beams in two adjacent repeated transmissions of the uplink channel to perform the transmissions toward different transmit-receive points (TRPs) of a same network device, determine a first transmission resource and a second transmission resource for performing the two adjacent repeated transmissions; there is a beam switching time for switching beam direction between the first transmission resource and the second transmission resource; the first transmission resource corresponds to a prior transmission occasion in two adjacent transmission occasions for transmissions of the uplink channel; and the second transmission resource corresponds to a late transmission occasion in the two adjacent transmission occasions for transmissions of the uplink channel.

The configuration signaling is configured to configure the first terminal to perform repeated transmission of same data in the uplink channel. The configuration signaling includes a transmission policy used determine transmission resources used by two adjacent repeated transmissions requiring beam direction switching. The first terminal, based on the transmission policy in the configuration signaling, determines the first transmission resource and the second transmission resource used by the two adjacent repeated transmissions. Two adjacent repeated transmissions of same data in the uplink channel are performed on the first transmission resource and the second transmission resource respectively.

The transmission policy is configured to indicate the first terminal on how to determine two transmission resources of two adjacent repeated transmissions in such a way that a beam switching time is present between the two transmission resources.

The first transmission resource corresponds to a prior transmission occasion in two adjacent transmission occasions, and performs uplink channel transmission by using abeam facing toward one TRP of synergic transmission. The second transmission resource corresponds to a late transmission occasion in the two adjacent transmission occasions.

Illustratively, the first transmission resource corresponds to an i-th transmission occasion, and the second transmission resource corresponds to a (i+1)-th transmission occasion, where i is a positive integer and the i-th transmission occasion and the (i+1)-th transmission occasion represent two sequential transmission occasions.

The transmission occasion includes a transmission resource on a time domain. The transmission occasion is at least one symbol on the time domain. Illustratively, the transmission occasion in the step 220 refers to an actual transmission occasion. The actual transmission occasion is an actual transmission occasion used by the first terminal to finally perform uplink channel transmission. Illustratively, relative to the actual transmission occasion, there is also a nominal transmission occasion, which is a transmission occasion the network device configures for the first terminal to performing uplink channel transmission. Illustratively, the first terminal may finally determine the actual transmission occasion for the repeated transmission of the uplink channel based on the nominal transmission occasion configured by the network device in combination with the beam switching time for switching beam direction.

Illustratively, the first terminal determines the first transmission resource and the second transmission resource based on a resource configuration of the uplink channel. The manners of determining the transmission resources by the terminal include deletion and delay. The deletion may refer to that at least one of the first transmission resource and the second transmission resource is determined by deleting the beam switching time. The delay refers to that the second transmission resource is determined by delaying the beam switching time after the first transmission resource.

Illustratively, the repeated transmissions of the uplink channel for same data include at least two repeated transmissions. At least two adjacent repeated transmissions in the step 220 refer to two adjacent repeated transmissions requiring beam direction switching in at least two repeated transmissions.

For example, the first terminal needs to perform four repeated transmissions. A first repeated transmission is performed toward a first TRP by using a first beam direction, a second repeated transmission is performed toward the first TRP by using the first beam direction, a third repeated transmission is performed toward a second TRP by using a second beam direction, and a fourth repeated transmission is performed toward a third TRP by using a third beam direction. In this case, the two adjacent repeated transmissions in the step 220 may be the second repeated transmission and the third repeated transmission or the third repeated transmission and the fourth repeated transmission.

Illustratively, the first transmission resource corresponds to the first transmission occasion, and the second transmission resource corresponds to the second transmission occasion; there is a time interval between an end symbol of the first transmission occasion and a start symbol of the second transmission occasion, where the time interval is greater than or equal to the beam switching time for beam direction switching.

Illustratively, the data transmitted in the uplink channel may be uplink data or uplink signaling.

Illustratively, the beam switching time is a time reserved for the first terminal to perform beam direction switching, where the beam switching time is configured or predefined by the network device.

At step 240, the terminal device receives the configuration signaling from the network device, where the configuration signaling includes the transmission policy of the uplink channel.

In conclusion, in the method provided by the embodiments of the present disclosure, by configuring two transmission resources spaced apart by a beam switching time for two adjacent repeated transmissions of an uplink channel respectively, different transmitting beams are used for the two repeated transmissions to perform transmission toward different TRPs of a same base station; due to presence of the beam switching time between the two transmission resources, the terminal device can perform beam switching when performing transmission of an uplink channel toward different TRPs by using different beam directions. The beam switching time can be reserved for the beam switching to help the terminal device to achieve repeated transmission of the uplink channel toward multiple TRPs of the same base station.

In the uplink-enhanced PUCCH/PUSCH transmission solutions based on multiple TRPs, the introduction configuration manner of the beam switching time in the transmission solutions is considered such that the transmission policy of the beam switching time configurable for the uplink transmission is supported, so as to optimize the transmission efficiency and reliability under different specific transmissions.

Illustratively, the signaling transmitted by the network device may at least include the following three cases.
(1) The network device transmits a first signaling where the first signaling carries the transmission policy.
(2) The network device transmits a first signaling and a second signaling, where the first signaling carries the transmission policy and the second signaling dynamically updates the transmission policy.
(3) The network device transmits a first signaling and a second signaling, where the signaling carries multiple candidate transmission policies, and the second signaling indicates a transmission policy from the multiple candidate transmission policies.

Based on the above three cases, the following three exemplary embodiments will be illustrated, where the three exemplary embodiments have no sequence.
(1) The network device transmits a first signaling, where the first signaling carries the transmission policy.

As shown in FIG. 3, it shows a flowchart of a method for configuring a transmission policy according to an embodiment of the present disclosure. The method may be applied to the system architecture shown in FIG. 1. The method may include the following steps.

At step 221, the network device transmits a radio resource control (RRC) signaling to the first terminal, where the RRC signaling includes the transmission policy of the uplink channel.

Illustratively, the network device can carry the transmission policy of the uplink channel in the RRC signaling such that the first terminal may, after receiving the RRC signaling, determine the transmission resources used by the repeated transmissions based on the transmission policy in the RRC signaling.

For example, the network device may configure delaying transmission “delaying” or deleting transmission “dropping” in the RRC signaling. Illustratively, the network device may also configure another transmission policy. The enumeration of the transmission policies will be detailed below in the following embodiments.

At step 241, the first terminal receives the RRC signaling from the network device, where the RRC signaling includes the transmission policy of the uplink channel.

In conclusion, in the method provided by the embodiments of the present disclosure, with the transmission policy carried in the RRC signaling, the network device configures the transmission policy for the first terminal by the RRC signaling such that the first terminal determines the first transmission resource and the second transmission resource used by two adjacent repeated transmissions based on the transmission policy. Due to presence of the beam switching time between the first transmission resource and the second transmission resource, the terminal device is helped to achieve repeated transmissions of the uplink channel toward multiple TRPs of the same base station.
(2) The network device transmits a first signaling and a second signaling, where the first signaling carries the transmission policy and the second signaling dynamically updates the transmission policy.

As shown in FIG. 4, it shows a flowchart illustrating a method for configuring a transmission policy according to an embodiment of the present disclosure. The method may be applied to the system architecture shown in FIG. 1. The method may include the following steps.

At step 222, the network device transmits a first signaling and a second signaling to the first terminal, where the first signaling includes the transmission policy of the uplink channel and the second signaling include indication information configured to dynamically update the transmission policy.

Illustratively, the first signaling is an RRC signaling, and the second signaling may be at least one of a media access control-control element (MAC-CE) signaling, a downlink control information (DCI) signaling and a packet DCI signaling.

For example, the first signaling includes a first transmission policy and the second signaling includes a second transmission policy. The first terminal receives the first signaling and determines the first transmission resource and the second transmission resource based on the first transmission policy. The first terminal receives the second signaling, and replaces the first transmission policy with the second transmission policy and then determines the first transmission resource and the second transmission resource based on the second transmission policy.

Illustratively, when the second signaling is a DCI signaling, the indication information is on a newly defined DCI domain in the DCI signaling; or, the indication information is on an unused DCI bit or a DCI reserved code point in the DCI signaling.

For example, one DCI domain is newly defined in the DCI signaling to carry the indication information including the transmission policy.

For another example, in the existing DCI domain of the DCI signaling, the indication information including the transmission policy is carried on the unused DCI bit or a DCI reserved code point. For example, the DCI reserved code point may be TPMI reserved code point.

Illustratively, when the second signaling is a packet DCI signaling, the indication information is on a DCI bit newly defined in the DCI domain corresponding to the first terminal in the packet DCI signaling; or the indication information is on the unused DCI code point or newly-added DCI code point in the DCI domain corresponding to the first terminal in the packet DCI signaling.

For another example, the packet DCI signaling includes the DCI domain corresponding to the first terminal and a DCI domain corresponding to a second terminal, and a DCI bit is newly defined in the DCI domain corresponding to the first terminal is configured to carry the indication information.

For another example, in the DCI domain corresponding to the first terminal, the indication information is carried on the unused code point; or in the DCI domain corresponding to the first terminal, the indication information is carried on the newly-added DCI code point.

At step 242, the first terminal receives the first signaling and the second signaling from the network device, where the first signaling includes the transmission policy of the uplink channel and the second signaling includes the indication information configured to dynamically update the transmission policy.

In conclusion, in the method provided by the embodiments of the present disclosure, since the first signaling carries the transmission policy and the second signaling is configured to dynamically update the transmission policy, the first terminal can determine the first transmission resource and the second transmission resource used by two adjacent repeated transmissions based on the transmission policy. Due to presence of the beam switching time between the first transmission resource and the second transmission resource, the terminal device is helped to achieve repeated transmissions of the uplink channel toward multiple TRPs of the same base station.
(3) The network device transmits a first signaling and a second signaling, where the first signaling carries multiple candidate transmission policies, and the second signaling indicates a transmission policy from the multiple candidate transmission policies.

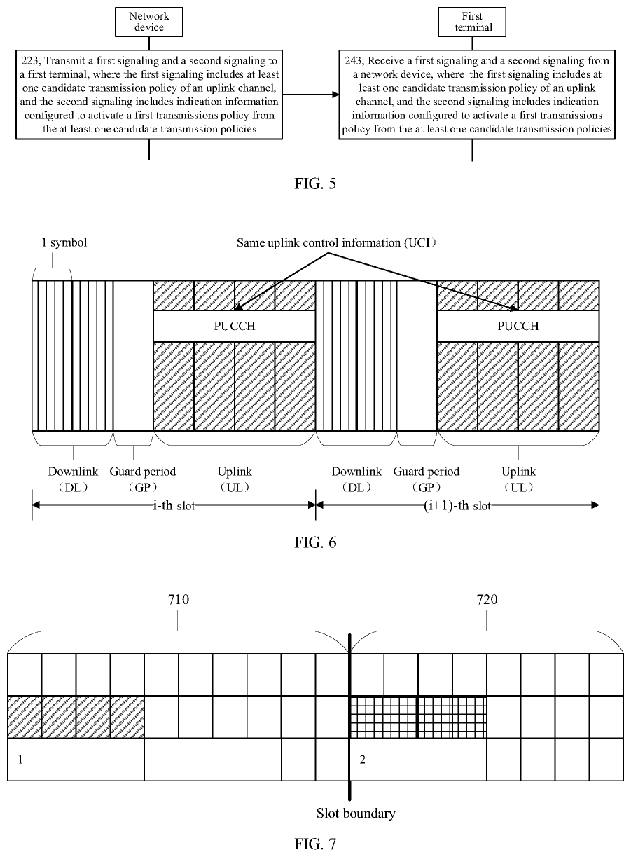

As shown in FIG. 5, it shows a flowchart of a method for configuring a transmission policy according to an embodiment of the present disclosure. The method may be applied to the system architecture shown in FIG. 1. The method includes the following steps.

At step 223, the network device transmits a first signaling and a second signaling to the first terminal, where the first signaling includes at least one candidate transmission policy of an uplink channel, and the second signaling includes indication information configured to activate a first transmissions policy from the at least one candidate transmission policies.

The first signaling carries multiple candidate transmission policies and the second signaling indicates a finally-used transmission policy from the multiple candidate transmission policies. Illustratively, the second signaling activates one transmission policy as the first transmission policy from the multiple candidate transmission polices, and thus, the first terminal may determine the transmission resources used by two adjacent repeated transmissions based on the first transmission policy. The indication information carried in the second signaling may include a deactivation instruction configured to deactivate a transmission policy.

Illustratively, the first signaling may also include a default activated transmission policy; the default activated transmission policy may be one of at least one candidate transmission policies.

When the first terminal does not receive the second signaling or the DCI domain where the indication information is in the second signaling is lost, the first terminal may directly adopt the default activated transmission policy and determine the transmission resources based on the transmission policy.

Illustratively, the first signaling is an RRC signaling, and the second signaling may be at least one of an MAC-CE signaling, a DCI signaling and a packet DCI signaling.

Illustratively, when the second signaling is a DCI signaling, the indication information is on the newly defined DCI domain in the DCI signaling; or, the indication information is on the unused DCI bit or a DCI reserved code point in the DCI signaling.

For example, one DCI domain is newly defined in the DCI signaling to carry the indication information. The indication information includes an activation instruction or a deactivation instruction. The activation instruction is configured to activate one candidate transmission policy as the first transmission policy and the deactivation instruction is configured to deactivate an activated transmission policy.

For another example, in the existing DCI domain of the DCI signaling, the indication information is carried on the unused DCI bit or a DCI reserved code point. For example, the DCI reserved code point may be a TPMI reserved code point.

Illustratively, when the second signaling is a packet DCI signaling, the indication information is on a DCI bit newly defined in the DCI domain corresponding to the first terminal in the packet DCI signaling; or the indication information is on the unused DCI code point or newly-added DCI code point in the DCI domain corresponding to the first terminal in the packet DCI signaling.

For another example, the packet DCI signaling includes the DCI domain corresponding to the first terminal and the DCI domain corresponding to the second terminal, and a DCI bit is newly defined in the DCI domain corresponding to the first terminal is configured to carry the indication information.

For another example, in the DCI domain corresponding to the first terminal, the indication information is carried on the unused code point; or in the DCI domain corresponding to the first terminal, the indication information is carried on the newly-added DCI code point.

At step 243, the first terminal receives the first signaling and the second signaling from the network device, where the first signaling includes at least one candidate transmission policy of the uplink channel, and the second signaling includes indication information configured to activate the first transmission policy from at least one candidate transmission policy.

In conclusion, in the method provided by the embodiments of the present disclosure, since the first signal carries multiple candidate transmission policies and the second signaling indicates one candidate transmission policy of the multiple candidate transmission policies as the transmission policy, the first terminal can determine the first transmission resource and the second transmission resource used by two adjacent repeated transmissions based on the transmission policy; due to the presence of the beam switching time between the first transmission resource and the second transmission resource, the terminal device is helped to achieve repeated transmissions of the uplink channel toward multiple TRPs of the same base station.

Illustratively, the uplink channel may be a physical uplink control channel (PUCCH) or a physical uplink shared channel (PUSCH).

The multi-TRP-based uplink channel enhancement solution is mainly based on the PUCCH/PUSCH repeated transmission solution of release 16 (R16). The uplink transmission solution of R16 is firstly introduced, namely, the PUCCH only supports the inter-slot repeated transmission, and the PUSCH supports the inter-slot repeated transmission type A mode and a repeated transmission type A mode of across-slot transmission.

### I. Intra-Slot Repeated Transmission of PUCCH

Considering uplink coverage problem for Release 15 (R15)/R16, a mechanism in which repeated transmissions are performed in multiple slots is introduced to the PUCCH (corresponding PUCCH format1/3/4), and different PUCCH resources perform transmission based on a same transmission symbol at different transmission occasions of each slot, as shown in FIG. 6. Only one PUCCH resource is used for one PUCCH repeated transmission and one beam direction spatialRelationInfo is configured for the PUCCH resource and applied to all transmission occasions. The network device configures supported corresponding repeated transmission number for the PUCCH format by using the RRC high-level signaling, where the range of the indicated repeated transmission number is defined as {1,2,4,8}, and different PUCCH resources may correspond to different PUCCH formats.

### II. Inter-Slot Repeated Transmission of PUSCH

Two manners of enhancing the uplink PUSCH time domain repeated transmission are: repeat type A transmission mode and repeat type B transmission mode introduced for R16.

### 1) PUSCH Repeat Type a Transmission Mode

R16 slot-level Slot Aggregation PUSCH transmission is applicable to those cases with requirements of low delay and high reliability. Transmission of one PUSCH is performed in K continuous slots, namely, there are k transmission occasions. Transmission is started from the S-th symbol in the start slot, and each transmission occasion lasts L symbols. Meanwhile, S+L does not go beyond the slot boundary. For example, as shown in FIG. 7, S equals 1, and L equals 4. The first terminal performs the first repeated transmission from the first symbol to the fourth symbol in the first slot 710, and performs the second repeated transmission from the first symbol to the fourth symbol in the second slot 720.

### 2) PUSCH Repeat Type B Transmission Mode

In order to reduce the delay and increase the reliability, R16 supports the PUSCH repeated transmission solution with mini-slot (also called “sub-slot”) as unit, and the PUSCH transmission is allowed to be across slot, further reducing the delay. In time domain, the transmission of one PUSCH is started from the S-th symbol in the start slot and k transmission occasions (nominal repetition) are transmitted continuously. Each transmission occasion occupies L symbols back-to-back, and the transmission of S+L may be across slot boundary.

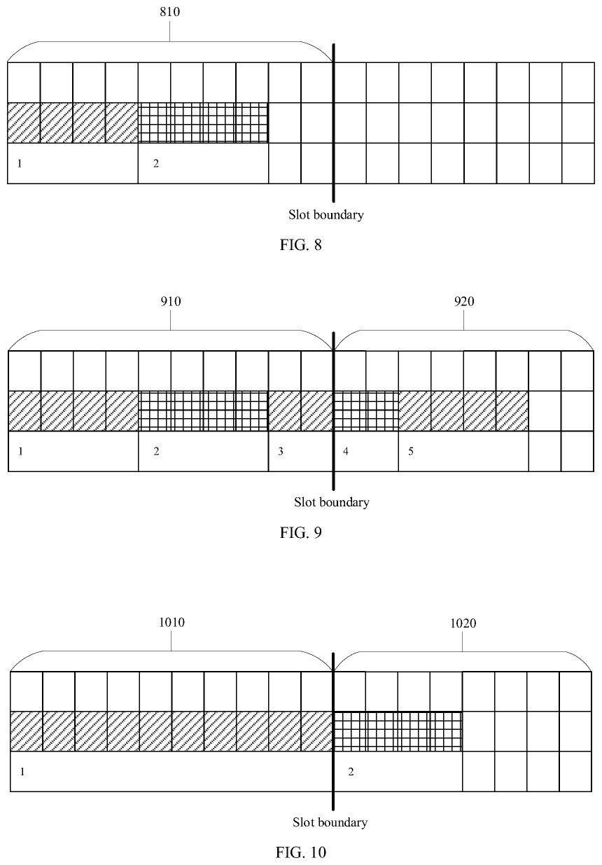

As shown in FIG. 8, when S equals 1, and L equals 4, the first terminal is configured to perform two repeated transmissions of the uplink channel. The first terminal performs the first repeated transmission from the first symbol to the fourth symbol in the first slot 810 and performs the second repeated transmission from the fifth symbol to the eighth symbol in the first slot.

In a case of the transmission occasion across slot boundary, the transmission may be re-divided.

As shown in FIG. 9, when S equals 1 and L equals 4, the first terminal is configured to perform four repeated transmissions of the uplink channel. The first terminal performs the first repeated transmission from the first symbol to the fourth symbol in the first slot 910 and performs the second repeated transmission from the fifth symbol to the eighth symbol in the first slot. Since four symbols for the third repeated transmission are across the slot boundary of the slot based on the configuration information, the third repeated transmission is divided into two repeated transmissions, namely, the third repeated transmission is performed from the ninth symbol to the tenth symbol in the first slot and the fourth repeated transmission is performed from the first symbol to the second symbol in the second slot 920. The fifth repeated transmission is performed from the third symbol to the seventh symbol in the second slot. Therefore, the first terminal actually performs five repeated transmissions, where same data is transmitted in each repeated transmission.

As shown in FIG. 10, when S equals 1 and L equals 14, the first terminal is configured to perform one repeated transmission of the uplink channel. Since one slot includes ten symbols and each transmission occasion occupies 14 symbols, 14 symbols for the first repeated transmission will be across slot boundary to divide the first repeated transmission into two repeated transmissions: the first repeated transmission is performed from the first symbol to the tenth symbol in the first slot 1010, and the second repeated transmission is performed from the first symbol to the fourth symbol in the second slot 1020. Therefore, the first terminal actually performs two repeated transmissions, where same data is transmitted in each repeated transmission.

For the entire transmission, the slot L*K represents a length of the time domain resource window of the PUSCH transmission, and downlink (DL) symbol is discarded to not be used in the transmission of PUSCH. The base station may configure short elementary file identifier (SFI) semistatic flexible symbol as dynamic uplink (UL) symbol or dynamic DL symbol, and hence, the semistatic Flexible symbol may be may be an available symbol or unavailable symbol for the PUSCH. When there is an available symbol, the first terminal needs to discard the unavailable symbol and then performs transmission on the remaining available symbol. The base station may also configure, by using a signaling, an invalid symbol pattern unavailable to the user equipment (UE), namely, the UE does not transmit uplink data on the invalid symbol indicated by the signaling.

In the R16 standardization, the multi-point-synergic-transmission-based enhanced transmission solution adopted by the downlink physical downlink shared channel (PDSCH) is mainly defined. In the multi-TRP/PANEL applications of the base station, the synergy between multiple TRPs or panels is used, and channel transmission and reception are performed by using multiple beams of different angles, so as to better overcome various blocking/stopping effects, and guarantee the robustness of the link connection. Thus, it is applicable to ultra reliable low latency communication (URLLC) services, improving transmission quality and satisfying reliability requirements. R17 needs to continue using the multi-TRP technology to enhance the uplink transmissions of, for example, the uplink control channel PUCCH and the uplink data channel PUSCH. In the R17 multi-TRP enhancement, the PUCCH/PUSCH supports synergically transmitting a same transport block (TB) toward different TRPs at different transmission occasions (TO) under the above defined transmission modes, so as to further apply spatial multiplexing transmission and improve transmission reliability.

For the PUCCH channel transmission, the possible solution of the R17 enhancement is as follows.

### I. Inter-Slot Repeated Transmission of PUCCH

Similar to the time division multiplexing (TDM) repeated transmission mode of R15/R16, time-sharing synergic transmission is performed toward multiple TRPs in multiple slots in multiple beam directions.

### II. Intra-Slot Repeated Transmission of PUCCH

Time-sharing joint transmission is performed toward multiple TRPs in one slot in multiple beam directions.

### 1) Sub-Slot-Based Transmission Solution

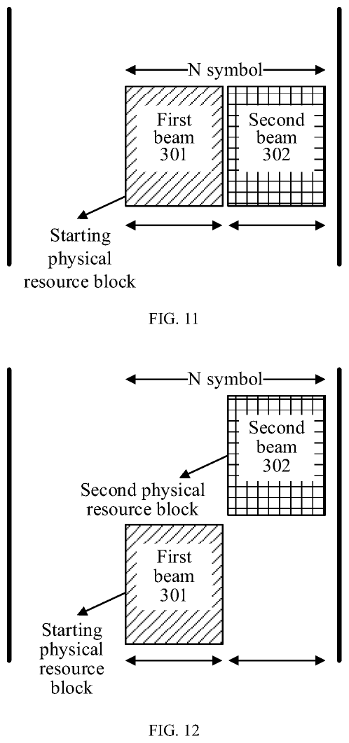

Repeated transmission of PUCCH is performed with the sub-slot as unit within a slot. For example, as shown in FIG. 11, two repeated transmissions of the uplink channel are performed within a slot; on two physical resource blocks of a same frequency domain within a slot, same data is transmitted toward multiple TRPs by using a first beam 301 and a second beam 302.

### 2) Transmission Solution Based on Intra-Slot Frequency Hopping Transmission

Within one PUCCH resource, transmission is performed by using different corresponding beams on different symbol groups (or called “physical resource block”) corresponding to previous and next hops within a slot. For example, as shown in FIG. 12, two repeated transmissions of the uplink channel are performed within a slot, and on two physical resource blocks of different frequency domains within a slot, same data is transmitted toward multiple TRPs by using the first beam 301 and the second beam 302.

Multiple mapping solutions may be considered for a mapping relationship between the beam transmitting directions in which the first terminal performs PUCCH/PUSCH transmission toward multiple TRPs and different transmission occasions. Three typical solutions are illustrated below.
Solution a: periodic mapping: two beam directions are mapped to multiple configured transmission occasions cyclically in sequence, for example, when four repeated transmissions are performed, the pattern of the beam direction mapping may be #1 #2 #1 #2, where #1 corresponds to a first beam direction and #2 corresponds to a second beam direction.
Solution b: continuous mapping: two beam directions are mapped to multiple configured transmission occasions continuously and cyclically, for example, for example, when four repeated transmissions are performed, the pattern of the beam direction mapping may be #1 #1 #2 #2; for more than four repeated transmissions, the pattern is repeated; for example, for eight repeated transmissions, the pattern of the beam direction mapping may be #1 #1 #2 #2 #1 #1 #2 #2.
Solution c: half mapping: two beam directions are mapped to multiple configured transmission occasions continuously, for example, when eight repeated transmissions are performed, the pattern of the beam direction mapping may be #1 #1 #1 #1 #2 #2 #2 #2.

The transmission policy includes one of a policy for deleting a beam switching time and a policy for delaying a beam switching time.

Illustratively, the policy for deleting the beam switching time refers to that: at least one of the first transmission resource and the second transmission resource is determined by deleting the beam switching time. The policy for delaying the beam switching time refers to that the second transmission resource is determined by delaying the beam switching time after the first transmission resource.

The deletion may be understood as determining two transmission resources after deleting the beam switching time from the nominal transmission occasions configured by the network device for two repeated transmissions; and the delay may be understood as obtaining an actual transmission occasion after delaying the beam switching time at the nominal transmission occasion corresponding to the late repeated transmission.

In combination with the above intra-slot repeated transmission mode of PUCCH and the repeat type B transmission mode of PUSCH, at least 12 transmission policies may be obtained as follows:
(I) For the sub-slot-based repeated transmission of PUCCH within a slot, the transmission resource is determined by deletion.

It is applied to the sub-slot-based PUCCH repeated transmission within a slot; the resource configuration of the uplink channel includes: configuring two continuous sub-slots for two adjacent repeated transmissions; the beam switching time is X symbols, the sub-slot includes M symbols, where X and M are positive integers and X is less than or equal to M.

The first terminal determines M symbols in the first sub-slot of the two sub-slots as the first transmission resource; determines the last (M-X) symbols in the second sub-slot of the two sub-slots as the second transmission resource.
(II) For the frequency-hopping-resource-based PUCCH repeated transmission within a slot, the transmission resources are determined based on equal distribution after the beam switching time is deleted from the transmission resources for two repeated transmissions.

It is applied to the PUCCH repeated transmission based on a same PUCCH resource within a slot; the resource configuration of the uplink channel includes: configuring N symbols of two adjacent repeated transmissions for the same PUCCH resource; the beam switching time is X symbols, where X is a positive integer, N is an integer greater than 1 and X is less than or equal to N.

The first terminal calculates (N−X)/2 and rounds down to obtain N1; calculates (N−X)/2 and rounds up to obtain N2; determines the first N1 symbols in the N symbols as the first transmission resource; and determines the last N2 symbols in the N symbols as the second transmission resource.
(III) For frequency-hopping-resource-based repeated transmission of PUCCH within a slot, the transmission resources are determined by deleting the beam switching time from the transmission resources corresponding to the second repeated transmission.

It is applied to the PUCCH repeated transmission based on a same PUCCH resource within a slot; the resource configuration of the uplink channel includes: configuring N symbols of two adjacent repeated transmissions for the same PUCCH resource; the beam switching time is X symbols, where X is a positive integer, N is an integer greater than 1 and X is less than N.

The first terminal calculates N/2 and rounds down to obtain N3; calculates N/2 and rounds up to obtain N4; determines the first N3 symbols in the N symbols as the first transmission resource; and determines the last (N4−X) symbols in the N symbols as the second transmission resource.
(IV) For the frequency-hopping-resource-based PUCCH repeated transmission within a slot, the transmission resources are determined based on equal distribution after the beam switching time is deleted from the remaining available transmission resources within the slot.

It is applied to the PUCCH repeated transmission based on a same PUCCH resource within a slot; the resource configuration of the uplink channel includes: configuring N symbols of two adjacent repeated transmissions for the same PUCCH resource, where there are Y symbols between the last symbol of the N symbols and the first symbol of the next slot; the beam switching time is X symbols, where X and Y are positive integers, and N is an integer greater than 1.

The first terminal calculates (Y+N−X)/2 and rounds down to obtain N5; calculates (Y+N−X)/2 and rounds up to obtain N6; determines the first N5 symbols in the (N+Y) symbols as the first transmission resource; and determines the last N6 symbols in the (N+Y) symbols as the second transmission resource.
(V) For the frequency-hopping-resource-based PUCCH repeated transmission within a slot, the transmission resources are determined by deleting the beam switching time from the transmission resources corresponding to the second repeated transmission in the remaining available transmission resources within the slot.

It is applied to the PUCCH repeated transmission based on a same PUCCH resource within a slot; the resource configuration of the uplink channel includes: configuring N symbols of two adjacent repeated transmissions for the same PUCCH resource, where there are Y symbols between the last symbol of the N symbols and the first symbol of the next slot; the beam switching time is X symbols, where X and Y are positive integers, and N is an integer greater than 1.

The first terminal calculates (Y+N)/2 and rounds down to obtain N7; calculates (Y+N)/2 and rounds up to obtain N8; determines the first N7 symbols in the (N+Y) symbols as the first transmission resource; and determines the last (N8-X) symbols in the (N+Y) symbols as the second transmission resource.
(VI) For the inter-slot repeat type B repeated transmission of PUSCH, the transmission resources are determined based on equal distribution after the beam switching time is deleted from the transmission resources for two repeated transmissions.

It is applied to the PUSCH repeated transmission of the cross-slot transmissions configured based on the nominal transmission occasions (“cross-slot transmission”); the resource configuration of the uplink channel may include: configuring two continuous nominal transmission occasions for two adjacent repeated transmissions, where each nominal transmission occasion occupies the time domain resource of A symbols, and the beam switching time is X symbols, where X and A are positive integers.

The first terminal determines A symbols in a prior nominal transmission occasion in the two nominal transmission occasions as the first transmission resource, and determines the last (A-X) symbols in a late nominal transmission occasion in the two nominal transmission occasions as the second transmission resource.
(VII) For the sub-slot-based PUCCH repeated transmission within a slot, the transmission resources are determined by delaying one sub-slot.

It is applied to the sub-slot-based PUCCH repeated transmission within a slot; the resource configuration of the uplink channel may include: configuring two continuous sub-slots for two adjacent repeated transmissions; the beam switching time is X symbols, and the sub-slot includes M symbols, where X and M are positive integers and X is less than or equal to M; the start symbol configured for two adjacent repeated transmissions is the S-th symbol in the slot, where S is a positive integer.

The first terminal determines the first sub-slot starting from the S-th symbol as the first transmission resource and determines the second sub-slot starting from the (S+2M)-th symbol as the second transmission resource, where the (S+2M)-th symbol is obtained by delaying one sub-slot for the first transmission resource.
(VIII) For the sub-slot-based PUCCH repeated transmission within a slot, the transmission resources are determined by delaying the beam switching time.

It is applied to the sub-slot-based PUCCH repeated transmission within a slot; the resource configuration of the uplink channel may include: configuring two continuous sub-slots for two adjacent repeated transmissions; the beam switching time is X symbols, and the sub-slot includes M symbols, where X and M are positive integers and X is less than or equal to M; the start symbol configured for two adjacent repeated transmissions is the S-th symbol in the slot, where S is a positive integer.

The first terminal determines the first sub-slot starting from the S-th symbol as the first transmission resource, and determines the second sub-slot starting from the (S+M+X)-th symbol as the second transmission resource, where the (S+M+X)-th symbol is obtained by delaying X symbols for the first transmission resource. In response to that the last Z symbols of the second sub-slot starting from the (S+M+X)-th symbol go beyond the slot boundary of the slot, the first terminal determines the first (M−Z) symbols in the second sub-slot as the second transmission occasion, where Z is a positive integer less than M.
(IX) For the frequency-hopping-resource-based repeated transmission of PUCCH within a slot, the transmission resources are determined by delaying the transmission resource corresponding to the second repeated transmission.

It is applied to the PUCCH repeated transmission based on a same PUCCH resource within a slot; the resource configuration of the uplink channel may include: configuring N symbols of two adjacent repeated transmissions for the same PUCCH resource, where there are Y symbols between the last symbol of the N symbols and the first symbol of the next slot; the beam switching time is X symbols, where X, Y and N are positive integers, and X is less than or equal to Y; the start symbol configured for two adjacent repeated transmissions is the S-th symbol in the slot, where S is a positive integer.

The first terminal calculates N/2 and rounds down to obtain N3; calculates N/2 and rounds up to obtain N4; determines N3 symbols starting from the S-th symbol as the first transmission resource; and determines N4 symbols starting from the (S+N3+X)-th symbol as the second transmission resource, where the (S+N3+X)-th symbol is obtained by delaying X symbols for the first transmission resource.
(X) For the frequency-hopping-resource-based repeated transmission of PUCCH within a slot, the transmission resources are determined by deleting the transmission resource going beyond the slot boundary after delaying the transmission resource corresponding to the second repeated transmission.

It is applied to the PUCCH repeated transmission based on a same PUCCH resource within a slot; the resource configuration of the uplink channel may include: configuring N symbols of two adjacent repeated transmissions for the same PUCCH resource, where there are Y symbols between the last symbol of the N symbols and the first symbol of the next slot; the beam switching time is X symbols, where X, Y and N are positive integers, and X is greater than or equal to Y; the start symbol configured for two adjacent repeated transmissions is the S-th symbol in the slot, where S is a positive integer.

The first terminal calculates N/2 and rounds down to obtain N3; calculates N/2 and rounds up to obtain N4; determines N3 symbols starting from the S-th symbol as the first transmission resource; and determines N4-(X-Y) symbols starting from the (S+N3+X)-th symbol as the second transmission resource, where the (S+N3+X)-th symbol is obtained by delaying X symbols for the first transmission resource.
(XI) For inter-slot repeat type B transmission mode of PUSCH, the transmission resources are determined by delaying the transmission resource corresponding to the second repeated transmission.

It is applied to the PUSCH repeated transmission of the cross-slot transmissions configured based on the nominal transmission occasions (“cross-slot transmission”); the resource configuration of the uplink channel may include: configuring two continuous nominal transmission occasions for two adjacent repeated transmissions, where each nominal transmission occasion occupies the time domain resource of A symbols, and the beam switching time is X symbols, where X and A are positive integers; the start symbol of two adjacent repeated transmissions is the S-th symbol in the slot, where S is a positive integer.

The first terminal determines A symbols starting from the S-th symbol s the first transmission resource, and determines A symbols starting from the (S+A+X)-th symbol as the second transmission resource, where the (S+A+X)-th symbol is obtained by delaying X symbols for the first transmission resource.
(XII) The transmission resources are determined by configuring the beam switching time as invalid symbol.

The network device transmits resource configuration of the uplink channel to the first terminal. The first transmission resource and the second transmission resource are determined based on resource configuration. The resource configuration includes configuring the beam switching time as invalid symbol. The first transmission resource and the second transmission resource are determined from valid symbols indicated by the resource configuration. The first terminal determines the first transmission resource and the second transmission resource based on the resource configuration of the uplink channel.

The above 12 transmission policies are illustrated without any sequence.

Illustratively, based on different application scenarios, the network device may configure different transmission policies for the first terminal.

For example, in response to that the number of the symbols in the sub-slot for performing one repeated transmission in the PUCCH is less than a threshold, the network device transmits a first configuration signaling to the first terminal, where the first configuration signaling includes a transmission policy of an uplink channel, which is a policy for delaying a beam switching time. When there are fewer symbols in the sub-slot, the reliability of the uplink data transmission can be guaranteed by using the policy for delaying transmission.

For another example, in response to that the number of the symbols in the sub-slot for performing one repeated transmission in the PUCCH is greater than the threshold, the network device transmits a second configuration signaling to the first terminal, where the second configuration signaling includes a transmission policy of an uplink channel, which is a policy for deleting the beam switching time. When there are more symbols in the sub-slot, the delay of the uplink transmission can be reduced by using the policy for deleting transmission.

For another example, in response to that the delay requirement in the PUSCH is higher than a threshold, the network device transmits the second configuration signaling to the first terminal, where the second configuration signaling includes a transmission policy of an uplink channel, which is a policy for deleting the beam switching time. When the uplink transmission has a high delay requirement, the delay of the uplink transmission can be reduced by using the policy for deleting transmission.

For another example, in response to that the delay requirement in the PUSCH is lower than the threshold, the network device transmits the first configuration signaling to the first terminal, where the first configuration signaling includes a transmission policy of an uplink channel, which is a policy for delaying the beam switching time. When the uplink transmission has a low delay requirement, the reliability of the uplink data transmission can be increased by using the policy for delaying transmission.

Illustratively, the network device may also, based on another scenario or requirement, configure a different transmission policy for the first terminal. For example, based on multiple scenarios such as specific transmission manner, slot resource distribution, service delay requirement, channel performance requirement and beam mapping manner and the like, the network device may correspondingly configure a proper transmission policy for the repeated transmissions of the uplink channel.

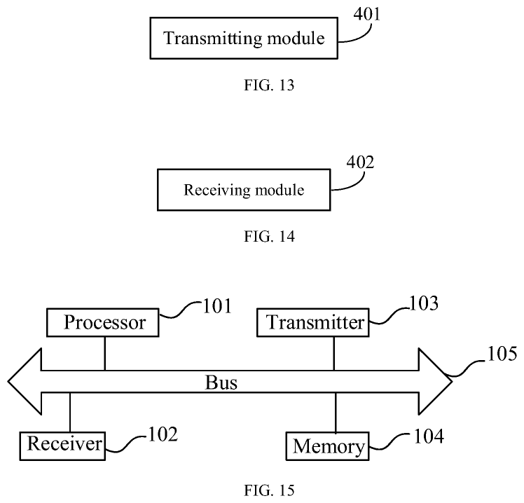

FIG. 13 is a structural block diagram illustrating an apparatus for configuring a transmission policy according to an exemplary embodiment of the present disclosure. The apparatus may be implemented as a network device, or a part of the network device. The apparatus includes:

a transmitting module 401, configured to transmit a configuration signaling to a first terminal, where the configuration signaling includes a transmission policy of an uplink channel;

where the transmission policy is configured to, when using different transmitting beams in two adjacent repeated transmissions of the uplink channel to perform the transmissions toward different transmit-receive points (TRPs) of a same network device, determine a first transmission resource and a second transmission resource for performing the two adjacent repeated transmissions; there is a beam switching time for switching beam direction between the first transmission resource and the second transmission resource; the first transmission resource corresponds to a prior transmission occasion in two adjacent transmission occasions for transmissions of the uplink channel; and the second transmission resource corresponds to a late transmission occasion in the two adjacent transmission occasions for transmissions of the uplink channel.

In one optional embodiment, the transmitting module 401 is configured to transmit a radio resource control (RRC) signaling to the first terminal, where the RRC signaling includes the transmission policy of the uplink channel.

In one optional embodiment, the transmitting module 401 is configured to transmit a first signaling and a second signaling to the first terminal, where the first signaling includes the transmission policy of the uplink channel and the second signaling includes indication information configured to dynamically update the transmission policy.

In one optional embodiment, the transmitting module 401 is configured to transmit a first signaling and a second signaling to the first terminal, where the first signaling includes at least one candidate transmission policy of the uplink channel, and the second signaling includes indication information configured to activate a first transmission policy from the at least one candidate transmission policy.

In one optional embodiment, the first signaling further includes a default activated transmission policy; and the default activated transmission policy is one of the at least one candidate transmission policies.

In one optional embodiment, the first signaling is an RRC signaling; the second signaling is at least one of media access control-control element (MAC-CE) signaling, downlink control information (DCI) signaling and packet DCI signaling.

In one optional embodiment, the second signaling is a DCI signaling and the indication information is on a newly defined DCI domain in the DCI signaling.

In one optional embodiment, the second signaling is a DCI signaling and the indication information is on an unused DCI bit or a DCI reserved code point in the DCI signaling.

In one optional embodiment, the second signaling is a packet DCI signaling, and the indication information is on a DCI bit newly defined in the DCI domain corresponding to the first terminal in the packet DCI signaling.

In one optional embodiment, the second signaling is a packet DCI signaling, and the indication information is on an unused DCI code point or newly-added DCI code point in the DCI domain corresponding to the first terminal in the packet DCI signaling.

In one optional embodiment, the transmission policy includes one of a policy for deleting the beam switching time and a policy for delaying the beam switching time.

FIG. 14 is a structural block diagram illustrating an apparatus for configuring a transmission policy according to an exemplary embodiment of the present disclosure. The apparatus may be implemented as a terminal device, or a part of the terminal. The apparatus includes:

a receiving module 402, configured to receive a configuration signaling from a network device, where the configuration signaling includes a transmission policy of an uplink channel;

where the transmission policy is configured to, when using different transmitting beams in two adjacent repeated transmissions of the uplink channel to perform the transmissions toward different transmit-receive points (TRPs) of a same network device, determine a first transmission resource and a second transmission resource for performing the two adjacent repeated transmissions; there is a beam switching time for switching beam direction between the first transmission resource and the second transmission resource; the first transmission resource corresponds to a prior transmission occasion in two adjacent transmission occasions for transmissions of the uplink channel; and the second transmission resource corresponds to a late transmission occasion in the two adjacent transmission occasions for transmissions of the uplink channel.

In one optional embodiment, the receiving module 402 is configured to receive a radio resource control (RRC) signaling from the network device, where the RRC signaling includes the transmission policy of the uplink channel.

In one optional embodiment, the receiving module 402 is configured to receive a first signaling and a second signaling from the network device, where the first signaling includes the transmission policy of the uplink channel, and the second signaling includes indication information configured to dynamically update the transmission policy.

In one optional embodiment, the receiving module 402 is configured to receive a first signaling and a second signaling from the network device, where the first signaling includes at least one candidate transmission policy of the uplink channel, and the second signaling includes indication information configured to activate a first transmission policy from the at least one candidate transmission policy.

In one optional embodiment, the first signaling further includes a default activated transmission policy; and the default activated transmission policy is one of the at least one candidate transmission policies.

In one optional embodiment, the first signaling is an RRC signaling; the second signaling is at least one of a media access control-control element (MAC-CE) signaling, a downlink control information (DCI) signaling or a packet DCI signaling.

In one optional embodiment, the second signaling is a DCI signaling and the indication information is on a newly defined DCI domain in the DCI signaling.

In one optional embodiment, the second signaling is a DCI signaling and the indication information is on an unused DCI bit or a DCI reserved code point in the DCI signaling.

In one optional embodiment, the second signaling is a packet DCI signaling, and the indication information is on a DCI bit newly defined in the DCI domain corresponding to the first terminal in the packet DCI signaling.

In one optional embodiment, the second signaling is a packet DCI signaling, and the indication information is on an unused DCI code point or newly-added DCI code point in the DCI domain corresponding to the first terminal in the packet DCI signaling.

In one optional embodiment, the transmission policy includes one of a policy for deleting the beam switching time and a policy for delaying the beam switching time.

FIG. 15 is a structural schematic diagram illustrating a communication device (terminal device or network device) according to an exemplary embodiment of the present disclosure. The communication device includes a processor 101, a receiver 102, a transmitter 103, a memory 104 and a bus 105.

The processor 101 includes one or more processing cores. The processor 101 runs software programs or modules to execute various function applications and information processing.

The receiver 102 and the transmitter 103 may be implemented as one communication component which may be a communication chip.

The memory 104 is connected with the processor 101 via the bus 105.

The memory 104 may be configured to store at least one instruction, and the processor 101 is configured to execute the at least one instruction to perform the steps in the above method embodiments.

Furthermore, the memory 104 may be implemented by any type of volatile or non-volatile storage devices or a combination thereof. The volatile or non-volatile storage device may include but not limited to a magnetic disk, or compact disk, an Electrically Erasable Programmable Read-Only Memory (EEPROM), an Erasable Programmable Read Only Memory (EPROM), a Static Random Access Memory (SRAM), a Read-Only Memory (ROM), a magnetic memory, a flash memory, and a Programmable Read-Only Memory (PROM).

When the communication device is implemented as a terminal device, the processor and the transceiver in the communication device involved in the embodiments of the present disclosure can execute the steps executable by the terminal device in the any one of the above methods, which will not be repeated herein.

In one possible implementation, when the communication device is implemented as the terminal device,

the transceiver is configured to receive a configuration signaling from the network device, where the configuration signaling includes a transmission policy of an uplink channel;

where the transmission policy is configured to, when using different transmitting beams in two adjacent repeated transmissions of the uplink channel to perform the transmissions toward different Transmit-Receive Points (TRPs) of a same network device, determine a first transmission resource and a second transmission resource for performing the two adjacent repeated transmissions; there is a beam switching time for switching beam direction between the first transmission resource and the second transmission resource; the first transmission resource corresponds to a prior transmission occasion in two adjacent transmission occasions for transmissions of the uplink channel; and the second transmission resource corresponds to a late transmission occasion in the two adjacent transmission occasions for transmissions of the uplink channel.

When the communication device is implemented as a network device, the processor and the transceiver in the communication device involved in the embodiments of the present disclosure can execute the steps executable by the network device in the any one of the above methods, which will not be repeated herein.

In one possible implementation, when the communication device is implemented as the network device,

the transceiver is configured to transmit a configuration signaling to the first terminal, where the configuration signaling includes a transmission policy of an uplink channel;

where the transmission policy is configured to, when using different transmitting beams in two adjacent repeated transmissions of the uplink channel to perform the transmissions toward different transmit-receive points (TRPs) of a same network device, determine a first transmission resource and a second transmission resource for performing the two adjacent repeated transmissions; there is a beam switching time for switching beam direction between the first transmission resource and the second transmission resource; the first transmission resource corresponds to a prior transmission occasion in two adjacent transmission occasions for transmissions of the uplink channel; and the second transmission resource corresponds to a late transmission occasion in the two adjacent transmission occasions for transmissions of the uplink channel.

In an illustrative embodiment, there is provided a computer readable storage medium, storing at least one instruction, at least one segment of programs, or a code set or an instruction set. The at least instruction, the at least one segment of programs, the code set or the instruction set may be loaded and executed by a processor to perform the method for configuring the transmission policy executable by the communication device according to each of the above method embodiments.

In an illustrative embodiment, there is provided a chip, including a programmable logic circuit and/or program instruction, where the chip is run on a computer device to perform the methods for configuring the transmission policy as mentioned in the above aspects.

In an illustrative embodiment, there is provided a computer program product, where the computer program product is run on a processor of a computer device to cause the computer device to perform the methods for configuring the transmission policy as mentioned in the above aspects.

In some embodiments, there is provided a method for configuring a transmission policy, performed by a network device and including: transmitting a configuration signaling to a first terminal, where the configuration signaling includes a transmission policy of an uplink channel, where the transmission policy is configured to, when using different transmitting beams in two adjacent repeated transmissions of the uplink channel to perform the transmissions toward different transmit-receive points (TRPs) of a same network device, determine a first transmission resource and a second transmission resource for performing the two adjacent repeated transmissions; there is a beam switching time for switching beam direction between the first transmission resource and the second transmission resource; the first transmission resource corresponds to a prior transmission occasion in two adjacent transmission occasions for transmissions of the uplink channel; and the second transmission resource corresponds to a late transmission occasion in the two adjacent transmission occasions for transmissions of the uplink channel.

In some embodiments, transmitting the configuration signaling to the first terminal includes: transmitting a radio resource control (RRC) signaling to the first terminal, where the RRC signaling includes the transmission policy of the uplink channel.

In some embodiments, transmitting the configuration signaling to the first terminal includes: transmitting a first signaling and a second signaling to the first terminal, where the first signaling includes the transmission policy of the uplink channel, and the second signaling includes indication information configured to dynamically update the transmission policy.

In some embodiments, transmitting the configuration signaling to the first terminal includes: transmitting a first signaling and a second signaling to the first terminal, where the first signaling includes at least one candidate transmission policy of the uplink channel, and the second signaling includes indication information configured to activate a first transmission policy from the at least one candidate transmission policy.

In some embodiments, the first signaling further includes a default activated transmission policy; and the default activated transmission policy is one of the at least one candidate transmission policies.

In some embodiments, the first signaling is an RRC signaling, and the second signaling is at least one of a media access control-control element (MAC-CE) signaling, a downlink control information (DCI) signaling or a packet DCI signaling.

In some embodiments, the second signaling is a DCI signaling, and the indication information is on a newly defined DCI domain in the DCI signaling.

In some embodiments, the second signaling is a DCI signaling, and the indication information is on an unused DCI bit or a DCI reserved code point in the DCI signaling.

In some embodiments, the second signaling is a packet DCI signaling, and the indication information is on a DCI bit newly defined in the DCI domain corresponding to the first terminal in the packet DCI signaling.

In some embodiments, the second signaling is a packet DCI signaling, and the indication information is on an unused DCI code point or newly-added DCI code point in the DCI domain corresponding to the first terminal in the packet DCI signaling.

In some embodiments, the transmission policy includes one of a policy for deleting the beam switching time and a policy for delaying the beam switching time.

In some embodiments, there is provided a method for configuring a transmission policy, performed by a network device and including: receiving a configuration signaling from a network device, where the configuration signaling includes a transmission policy of an uplink channel; where the transmission policy is configured to, when using different transmitting beams in two adjacent repeated transmissions of the uplink channel to perform the transmissions toward different transmit-receive points (TRPs) of a same network device, determine a first transmission resource and a second transmission resource for performing the two adjacent repeated transmissions; there is a beam switching time for switching beam direction between the first transmission resource and the second transmission resource; the first transmission resource corresponds to a prior transmission occasion in two adjacent transmission occasions for transmissions of the uplink channel; and the second transmission resource corresponds to a late transmission occasion in the two adjacent transmission occasions for transmissions of the uplink channel.

In some embodiments, receiving the configuration signaling from the network device includes: receiving a radio resource control (RRC) signaling from the network device, where the RRC signaling includes the transmission policy of the uplink channel.

In some embodiments, receiving the configuration signaling from the network device includes: receiving a first signaling and a second signaling from the network device, where the first signaling includes the transmission policy of the uplink channel, and the second signaling includes indication information configured to dynamically update the transmission policy.

In some embodiments, receiving the configuration signaling from the network device includes: receiving a first signaling and a second signaling from the network device, where the first signaling includes at least one candidate transmission policy of the uplink channel, and the second signaling includes indication information configured to activate a first transmission policy from the at least one candidate transmission policy.

In some embodiments, the first signaling further includes a default activated transmission policy; and the default activated transmission policy is one of the at least one candidate transmission policies.

In some embodiments, the first signaling is an RRC signaling; the second signaling is at least one of a media access control-control element (MAC-CE) signaling, a downlink control information (DCI) signaling or a packet DCI signaling.

In some embodiments, the second signaling is a DCI signaling and the indication information is on a newly defined DCI domain in the DCI signaling.

In some embodiments, the second signaling is a DCI signaling and the indication information is on an unused DCI bit or a DCI reserved code point in the DCI signaling.

In some embodiments, the second signaling is a packet DCI signaling, and the indication information is on a DCI bit newly defined in the DCI domain corresponding to the first terminal in the packet DCI signaling.

In some embodiments, the second signaling is a packet DCI signaling, and the indication information is on an unused DCI code point or newly-added DCI code point in the DCI domain corresponding to the first terminal in the packet DCI signaling.

In some embodiments, the transmission policy includes one of a policy for deleting the beam switching time and a policy for delaying the beam switching time.

In some embodiments, there is provided an apparatus for configuring a transmission policy, including: a transmitting module, configured to transmit a configuration signaling to a first terminal, where the configuration signaling includes a transmission policy of an uplink channel; where the transmission policy is configured to, when using different transmitting beams in two adjacent repeated transmissions of the uplink channel to perform the transmissions toward different transmit-receive points (TRPs) of a same network device, determine a first transmission resource and a second transmission resource for performing the two adjacent repeated transmissions; there is a beam switching time for switching beam direction between the first transmission resource and the second transmission resource; the first transmission resource corresponds to a prior transmission occasion in two adjacent transmission occasions for transmissions of the uplink channel; and the second transmission resource corresponds to a late transmission occasion in the two adjacent transmission occasions for transmissions of the uplink channel.

In some embodiments, there is provided an apparatus for configuring a transmission policy, including: a receiving module, configured to receive a configuration signaling from a network device, where the configuration signaling includes a transmission policy of an uplink channel; where the transmission policy is configured to, when using different transmitting beams in two adjacent repeated transmissions of the uplink channel to perform the transmissions toward different transmit-receive points (TRPs) of a same network device, determine a first transmission resource and a second transmission resource for performing the two adjacent repeated transmissions; there is a beam switching time for switching beam direction between the first transmission resource and the second transmission resource; the first transmission resource corresponds to a prior transmission occasion in two adjacent transmission occasions for transmissions of the uplink channel; and the second transmission resource corresponds to a late transmission occasion in the two adjacent transmission occasions for transmissions of the uplink channel.

In some embodiments, there is provided a network device, including a processor and a transceiver connected with the processor; where the transceiver is configured to transmit a configuration signaling to a first terminal, where the configuration signaling includes a transmission policy of an uplink channel; where the transmission policy is configured to, when using different transmitting beams in two adjacent repeated transmissions of the uplink channel to perform the transmissions toward different transmit-receive points (TRPs) of a same network device, determine a first transmission resource and a second transmission resource for performing the two adjacent repeated transmissions; there is a beam switching time for switching beam direction between the first transmission resource and the second transmission resource; the first transmission resource corresponds to a prior transmission occasion in two adjacent transmission occasions for transmissions of the uplink channel; and the second transmission resource corresponds to a late transmission occasion in the two adjacent transmission occasions for transmissions of the uplink channel.

In some embodiments, there is provided a terminal device, including a processor and a transceiver connected with the processor; where the transceiver is configured to receive a configuration signaling from a network device, where the configuration signaling includes a transmission policy of an uplink channel; where the transmission policy is configured to, when using different transmitting beams in two adjacent repeated transmissions of the uplink channel to perform the transmissions toward different transmit-receive points (TRPs) of a same network device, determine a first transmission resource and a second transmission resource for performing the two adjacent repeated transmissions; there is a beam switching time for switching beam direction between the first transmission resource and the second transmission resource; the first transmission resource corresponds to a prior transmission occasion in two adjacent transmission occasions for transmissions of the uplink channel; and the second transmission resource corresponds to a late transmission occasion in the two adjacent transmission occasions for transmissions of the uplink channel.

In some embodiments, there is provided a computer readable storage medium, storing executable instructions thereon, where the executable instructions, when loaded and executed by a processor, cause the processor to perform the above-mentioned methods for configuring the transmission policy.

In some embodiments, there is provided a chip, including programmable logic circuits or programs, where the chip is configured to perform the above-mentioned methods for configuring the transmission policy.

In some embodiments, there is provided a computer program product, which runs on a processor of a computer device to cause the computer device to perform the above-mentioned methods for configuring the transmission policy.

The technical solutions provided by the embodiments of the present disclosure may at least have the following beneficial effects.

By configuring two transmission resources spaced apart by a beam switching time for two adjacent repeated transmissions of an uplink channel respectively, different transmitting beams are used for the two repeated transmissions to perform transmission toward different TRPs of a same base station; due to presence of the beam switching time between the two transmission resources, the terminal device can perform beam switching when performing transmission of an uplink channel toward different TRPs by using different beam directions. The beam switching time can be reserved for the beam switching to help the terminal device to achieve repeated transmission of the uplink channel toward multiple TRPs of the same base station.

Persons of ordinary skills in the prior arts can understand that all or part of the steps of the above embodiments can be performed by hardware or by a program instructing relevant hardware. The program can be stored in a computer readable storage medium. The above mentioned storage medium may be a read only memory, a magnetic disk or a compact disk or the like.

The above are only optional embodiments of the present disclosure and not used to limit the present disclosure. Any changes, equivalent substitutions and improvements and the like made within the spirit and principle of the present disclosure shall fall within the scope of protection of the present disclosure.

1. A method for configuring a transmission policy, performed by a network device and comprising:
transmitting a configuration signaling to a first terminal, wherein the configuration signaling comprises a transmission policy of an uplink channel,
wherein the transmission policy is configured to, when using different transmitting beams in two adjacent repeated transmissions of the uplink channel to perform the transmissions toward different transmit-receive points (TRPs) of a same network device, determine a first transmission resource and a second transmission resource for performing the two adjacent repeated transmissions;
there is a beam switching time for switching beam direction between the first transmission resource and the second transmission resource; the first transmission resource corresponds to a prior transmission occasion in two adjacent transmission occasions for transmissions of the uplink channel; and the second transmission resource corresponds to a late transmission occasion in the two adjacent transmission occasions for transmissions of the uplink channel.

2. The method of claim 1, wherein transmitting the configuration signaling to the first terminal comprises:
transmitting a radio resource control (RRC) signaling to the first terminal, wherein the RRC signaling comprises the transmission policy of the uplink channel.

3. The method of claim 1, wherein transmitting the configuration signaling to the first terminal comprises:
transmitting a first signaling and a second signaling to the first terminal, wherein the first signaling comprises the transmission policy of the uplink channel, and the second signaling comprises indication information configured to dynamically update the transmission policy.

4. The method of claim 1, wherein transmitting the configuration signaling to the first terminal comprises:
transmitting a first signaling and a second signaling to the first terminal, wherein the first signaling comprises at least one candidate transmission policy of the uplink channel, and the second signaling comprises indication information configured to activate a first transmission policy from the at least one candidate transmission policy,
wherein the first signaling further comprises a default activated transmission policy; and the default activated transmission policy is one of the at least one candidate transmission policies.

5. (canceled)

6. The method of claim 3, wherein the first signaling is an RRC signaling, and the second signaling is at least one of a media access control-control element (MAC-CE) signaling, a downlink control information (DCI) signaling or a packet DCI signaling.

7. The method of claim 6, wherein the second signaling is a DCI signaling, and the indication information is on a Newly defined DCI domain, an unused DCI bit, or a DCI reserved code point in the DCI signaling.

8. (canceled)

9. The method of claim 6, wherein the second signaling is a packet DCI signaling, and the indication information is on a DCI bit newly defined in the DCI domain corresponding to the first terminal in the packet DCI signaling.

10. The method of claim 6, wherein the second signaling is a packet DCI signaling, and the indication information is on an unused DCI code point or newly-added DCI code point in the DCI domain corresponding to the first terminal in the packet DCI signaling.

11. The method of claim 1, wherein the transmission policy comprises at least one of a policy for deleting the beam switching time or a policy for delaying the beam switching time.

12. A method for configuring a transmission policy, performed by a first terminal and comprising:
receiving a configuration signaling from a network device, wherein the configuration signaling comprises a transmission policy of an uplink channel;
wherein the transmission policy is configured to, when using different transmitting beams in two adjacent repeated transmissions of the uplink channel to perform the transmissions toward different transmit-receive points (TRPs) of a same network device, determine a first transmission resource and a second transmission resource for performing the two adjacent repeated transmissions; there is a beam switching time for switching beam direction between the first transmission resource and the second transmission resource; the first transmission resource corresponds to a prior transmission occasion in two adjacent transmission occasions for transmissions of the uplink channel; and the second transmission resource corresponds to a late transmission occasion in the two adjacent transmission occasions for transmissions of the uplink channel.

13. The method of claim 12, wherein receiving the configuration signaling from the network device comprises:
receiving a radio resource control (RRC) signaling from the network device, wherein the RRC signaling comprises the transmission policy of the uplink channel.

14. The method of claim 12, wherein receiving the configuration signaling from the network device comprises:
receiving a first signaling and a second signaling from the network device, wherein the first signaling comprises the transmission policy of the uplink channel, and the second signaling comprises indication information configured to dynamically update the transmission policy.

15. The method of claim 12, wherein receiving the configuration signaling from the network device comprises:
receiving a first signaling and a second signaling from the network device, wherein the first signaling comprises at least one candidate transmission policy of the uplink channel, and the second signaling comprises indication information configured to activate a first transmission policy from the at least one candidate transmission policy,
wherein the first signaling further comprises a default activated transmission policy; and the default activated transmission policy is one of the at least one candidate transmission policies.

16. (canceled)

17. The method of claim 14, wherein the first signaling is an RRC signaling; the second signaling is at least one of a media access control-control element (MAC-CE) signaling, a downlink control information (DCI) signaling or a packet DCI signaling.

18. The method of claim 17, wherein the second signaling is a DCI signaling and the indication information is on a newly defined DCI domain, an unused DCI bit, or a DCI reserved code point in the DCI signaling.

19. (canceled)

20. The method of claim 17, wherein the second signaling is a packet DCI signaling, and the indication information is on a DCI bit newly defined in the DCI domain corresponding to the first terminal in the packet DCI signaling.

21. The method of claim 17, wherein the second signaling is a packet DCI signaling, and the indication information is on an unused DCI code point or newly-added DCI code point in the DCI domain corresponding to the first terminal in the packet DCI signaling.

22. The method of claim 12, wherein the transmission policy comprises at least one of a policy for deleting the beam switching time or a policy for delaying the beam switching time.

23. (canceled)

24. (canceled)

25. A network device, comprising a processor and a transceiver connected with the processor; wherein,
the transceiver is configured to transmit a configuration signaling to a first terminal, wherein the configuration signaling comprises a transmission policy of an uplink channel;
wherein the transmission policy is configured to, when using different transmitting beams in two adjacent repeated transmissions of the uplink channel to perform the transmissions toward different transmit-receive points (TRPs) of a same network device, determine a first transmission resource and a second transmission resource for performing the two adjacent repeated transmissions; there is a beam switching time for switching beam direction between the first transmission resource and the second transmission resource; the first transmission resource corresponds to a prior transmission occasion in two adjacent transmission occasions for transmissions of the uplink channel; and the second transmission resource corresponds to a late transmission occasion in the two adjacent transmission occasions for transmissions of the uplink channel.

26. A terminal device, comprising a processor and a transceiver connected with the processor; wherein,
the transceiver is configured to perform the method of claim 12.

27. (canceled)

28. (canceled)
